(19) United States
(12) Patent Application Publication
(10) Pub. No.: US 2001/0043327 A1
(43) Pub. Date: Nov. 22, 2001

(54) Spectral identification system

(76) Inventors: Bryan Barney, Aptos, CA (US); Leonard Kamlet, San Jose, CA (US); Alson Spores, Antioch, CA (US)

Correspondence Address: STETINA BRUNDA GARRED & BRUCKER, 75 ENTERPRISE, SUITE 250, ALISO VIEJO, CA, 92656, US

(21) Appl. No.: 09/827,455

(22) Filed: Apr. 6, 2001

Related U.S. Application Data
(60) Provisional application No. 60/195,882, filed on Apr. 7, 2000.

(51) Int. Cl. G01J 3/28

(52) U.S. Cl. 356/326

(57) ABSTRACT

A method and apparatus for spectral identification of a material based on a spectral signature. The method is ideally suited for thin film substrate characterization, as found in semiconductor wafer and optical thin film processing.

### CROSS-REFERENCE TO RELATED APPLICATIONS

The present application claims priority in the U.S. Provisional Application Ser. No. 60/195,882 entitled Spectral Identification System filed Apr. 6, 2000.

### STATEMENT RE: FEDERALLY SPONSORED RESEARCH/DEVELOPMENT

(Not Applicable)

### BACKGROUND OF THE INVENTION

The present invention relates to a method for identification of a material or product through an analysis of its signature spectral response.

In many processes, including the processing of semiconductor wafers or optical thin films, there may be a process step that allows a number of different inputs which are acceptable for that stage of the process, but cannot accept other inputs. For example, an etch chamber may be able to handle wafers with the top layer consisting of photo resist or silicon oxide, but cannot handle a wafer that has any metal exposed. To place a metal wafer into the wrong process chamber can destroy that product and contaminate the chamber. This condition is one to be avoided.

While a multitude of precautions are taken in the process flow to prevent the wrong materials from being placed into a process chamber, there is often no visual inspection that can be done in these situations to protect the chamber. For these processes an automated system is desired which can detect whether the water is acceptable for the process chamber or not.

Electronically processed signals from optical metrology—the measure of light reflected or transmitted from a material—can provide additional information about the nature of a material that cannot be determined solely through visual inspection. Optical metrology is a good candidate for providing this type of sample classification, providing a signature that can be used to classify the samples into the correct bin. In fact, optical signals are routinely used in other industries; for instance the agriculture industry uses optical metrology for sorting fruits, vegetables and grains.

Previous optical identification systems have used single wavelength detection systems or a measure of the color of a material, as identified by its optical properties, to identify and classify items. Others have used machine vision systems to define the boundaries of an imaged part and classify that part based on size. Systems such as these fail to meet the needs of classifying semiconductor or other optically thin films, since size usually is not a factor and color may not be the correct criteria to distinguish between samples.

More sophisticated optical metrology, such as reflectometry and ellipsometry, exist as methods of describing the material present on a semiconductor wafer or thin film substrate, but they do not perform the task of classification other than possibly in a pass/fail capacity. These methods require a model that already has the films identified, and then they report refined values of those modeled values. The coarse identification of the material still must be done manually or through a recipe, but the instrument is not involved in this selection.

### BRIEF SUMMARY OF THE INVENTION

To overcome the limitations of the above measurements, this invention provides a new method for identification and classification of materials through the spectral signature of the material obtained from an optical reflection or transmission measurement.

The present invention provides: The generation and collection of multiple wavelengths from ultra-violet and/or visible to near infra-red light signals, either reflected off the surface of a sample or product or transmitted through that sample; possible evaluation or data analysis of that signal to identify the shape and location of features found in the spectral response; a means of comparison of the signature of this spectral response (or the results of the above analysis) to a database of expected product signatures to identify the sample or product as being a member of one of two or more categories of product; and a means of sending an electrical signal output to signify to which category the product belongs.

The design of the present invention uses a reflection measurement with either a bundled fiber for both illumination and detection or a beam splitter with separate fibers for illumination and detection. The fixed angle of incidence and reflection chosen is normal incidence, perpendicular to the surface of the material. The apparatus of the present invention may be mounted on a process chamber so that the measurement can be done in-line rather than needing to go to a stand-alone tool.

It should be noted and understood that with respect to the embodiments of the present invention, the materials suggested may be modified or substituted to achieve the general overall result. The substitution of materials or dimensions remain within the spirit and scope of the present invention.

### BRIEF DESCRIPTION OF THE DRAWINGS

These, as well as other features of the present invention, will become more apparent upon reference to the drawings wherein:

FIG. 1 is a schematic showing optical fiber coming from lamp, delivering light to a optical collimator and focusing lens;

FIG. 2 is a schematic showing the angle of incidence and angle of reflection through a material or film stack;

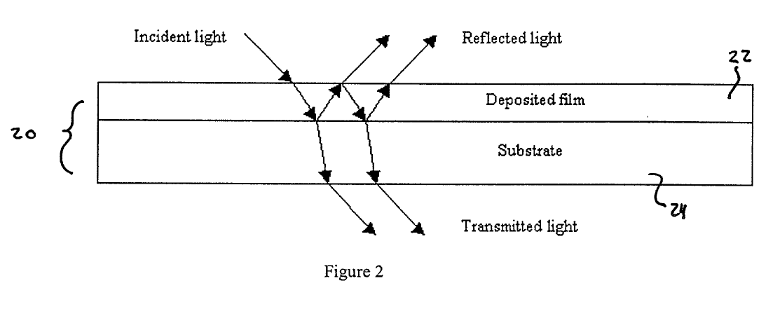

FIG. 3 is a schematic showing a beam splitter reflectance probe, fibers going to detector and from lamp, connections from detector hardware to computer and for output classification signals, with probe positioned above and at normal incidence to sample. A fiber connected to the lamp goes into the side input of the beam splitter, and the fiber leading to the detector is attached to the top input on the beam splitter, opposite the surface of the material;

FIG. 4 is a schematic showing reflectance probes, with a special reflectance fiber going to detector and from lamp, connections from detector hardware to computer and for output classification signals, with probes positioned above and below, at normal incidence to sample;

FIG. 5 is a schematic showing transmission probes, with fibers going to detector and from lamp, connections from detector hardware to computer and for output classification signals, with probes positioned above and below, at normal incidence to sample;

FIG. 6 is a schematic showing reflection probes, with fibers going to detector and from lamp, connections from detector hardware to computer and for output classification signals, with probes positioned at equal angles of incidence and reflection relative to normal, above the sample;

FIG. 7 is a flow chart showing the basic steps the computer software uses to identify the material from its spectral response.

### DETAILED DESCRIPTION OF THE INVENTION

The detailed description as set forth below in connection with the appended drawings is intended as a description of the presently preferred embodiments of the present invention, and are not intended to represent the only form in which the present invention may be constructed or utilized. The description sets forth functions and sequence of steps for constructing and operating the invention in connection with the illustrated embodiments. It is understood, however, the same or equivalent functions and sequences may be accomplished by different embodiments and that they are also intended to be encompassed within the spirit and scope of this invention.

Optical metrology is a good method for providing sample classification. Furthermore, the spectral response (using data from light signals whose wavelengths are in the ultra-violet (UV) to near infra-red (NIR) (190 nm-1100 nm or a subset thereof) from these samples provides a signature that can be used to classify the samples into the correct bin.

The system requires the ability to generate light at multiple wavelengths. There are a number of lamps that provide high quality broad spectral response from at least a portion of UV to NIR, such as lamps made from tungsten-halogen, quartz-tungsten-halogen, Xenon, metal halides, and deuterium. The light is used to illuminate the material to be identified. The easiest method of doing this is to place the lamp in a position where it can directly illuminate the material. In most applications, however, this has a drawback that the light is not focused on the material, and the angle of incidence is often hard to adjust with the accuracy necessary.

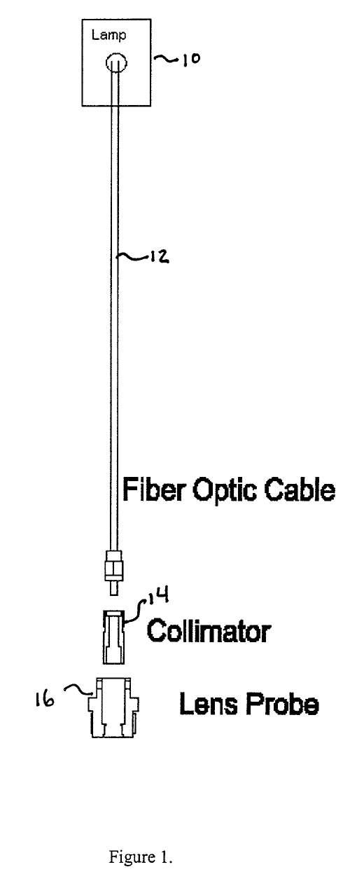

The design of the present invention uses optical fibers, lenses, and collimating optics as shown in FIG. 1. Light from the lamp 10 is focused into a fiber 12, and then is collimated through a collimator 14 and brought to a lens probe 16 mounted at a known angle relative to the material being measured. Reference to the mounting hardware for the lens, the specific angle of incidence chosen, and the ability to set this angle is not part of FIG. 1 as the same can be achieved through a number of methods.

Incident light focused on a material 20 (consisting of one or more thin films 22 deposited on a substrate 24) at a known angle of incidence has specular reflectance at a known angle of reflection that is equal to the angle of incidence. If the material 22 is transparent or opaque, specular light is transmitted through it and comes out of the sample with the same angle as the angle of incidence.

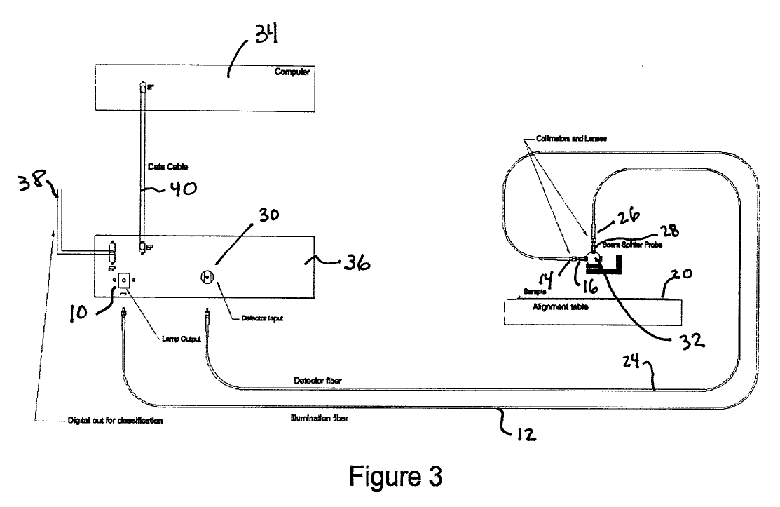

Once the light is either transmitted or reflected, the light needs to be collected and sent to a detector. It is advantageous to place the detector in the location where the light is to be collected, however, such a design may not be practical. The design of the present invention, referring to FIG. 3, includes a lensed optical fiber 24, with a collimator 26 for coupling the light from the lens 28 to the fiber 24, and the other end of the fiber 24 connected so that it couples the light into the detector 30. The detector 30 must be able to collect light and report the intensity of light at multiple wavelengths. The design of the present invention utilizes a photodiode array, charge-coupled device (CCD) array, or a monochromator capable of scanning multiple wavelengths. An alternate design may include a means to split the light and send it into multiple single-wavelength detectors. Any means that would satisfy the requirement of collecting light at multiple wavelengths may be utilized.

The design of the present invention measures the material 20 with the incident light at an angle normal (perpendicular) to the surface. The reflected signal would then return at the same angle, and if there is light transmitted it would also come through at an angle normal to the back surface of the material. The system of the present invention then would detect the reflectance of the material rather than the transmittance, as many of the materials targeted by this invention (such as semiconductor materials) are not transparent to light in the visible spectrum. Also shown in FIG. 3 is the use of a beam splitter probe 32 to allow both the illumination fiber 12 and detection fiber 24 to be mounted to a single fixture. This special beam splitter probe 32 in the light path allows a portion of the illumination light to pass through it while another portion is deflected toward the material 20 to be measured. The light reflected from the surface again hits the probe 32, and a portion of the light is directed back toward the illumination fiber 12 while the remainder of the light passes through the beam splitter probe 28 and into the detection fiber 24. It should be noted that the configuration of the beam splitter probe 32 allows for the illumination fiber 12 and detection fiber 24 positions to be reversed with no change in performance.

The detector 30 interfaces with a computer 34 through a data cable 40, which stores data and analyzes the detected light trough software and hardware. Computer 30 may forward instructions to the lamp/detector unit 36 to provide digital output 38 for classification.

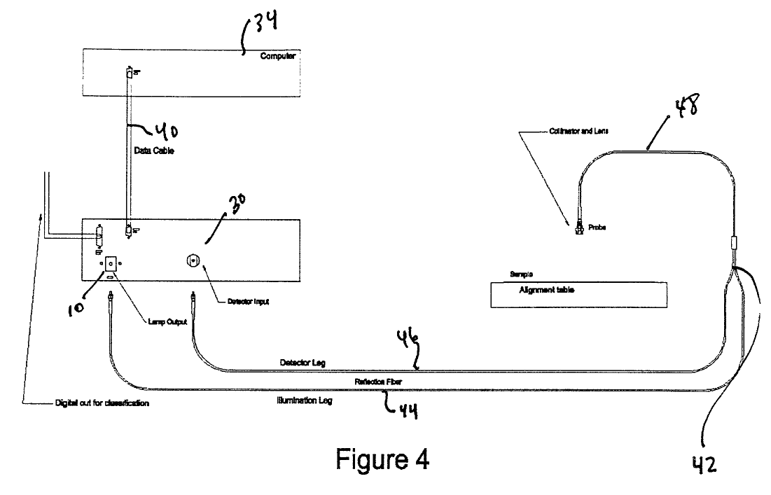

A alternate embodiment for the present invention uses a different type of fiber with a shared common end at the fixture near the material as shown in FIG. 4. This alternate embodiment employs a reflective fiber 42 comprised of an illumination leg 44 and a detector leg 46. The common end 48 has six individual fibers used for illumination, surrounding a central fiber used for detection. The six fibers are separated from the seventh away from the common end, and the six are coupled to the lamp 10 while the detection fiber 46 returns to the detector 30.

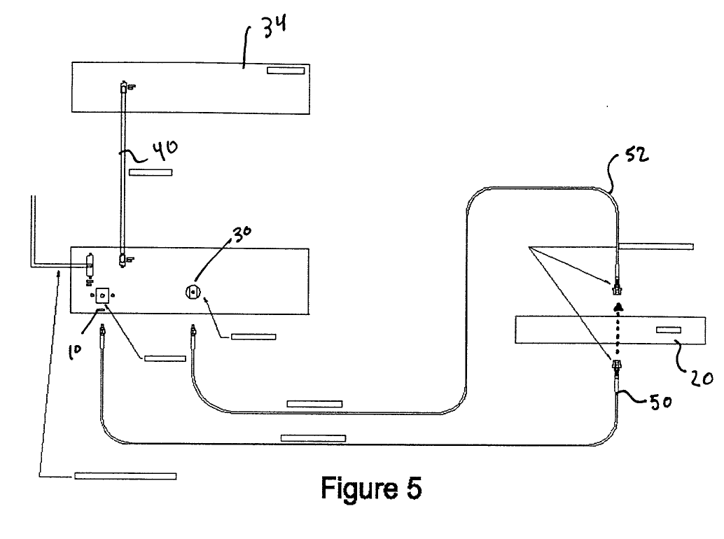

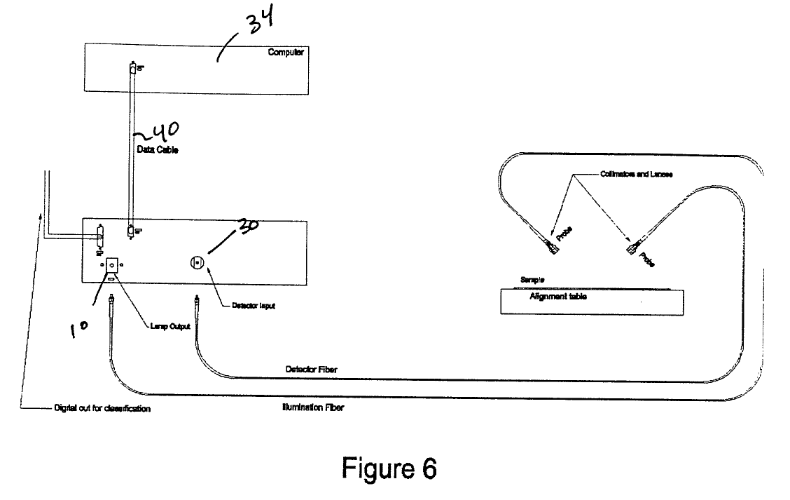

Two alternate embodiments of the hardware portion of the invention are shown in FIG. 5 and FIG. 6. FIG. 5 uses normal incidence, but measures the light transmitted through the material 20 by placing the illumination fiber 50 and the detection fiber 52 on either side of the material 20. FIG. 6 again uses reflectance, but uses an angle other than normal incidence and thus an equal angle of reflectance for detection.

In each of these embodiments, once the signal is received by the detector 30 hardware electronics converts the signal from the detector 30 into a scaled current or voltage indicative of the intensity of light detected at each wavelength. A gain stage amplifier of either the electrical signal or the light detector itself may be required as part of this detection system in order to convert the signal received into a useful value. The set of values from the intensity measurements from the multiple wavelengths selected for monitoring are then passed into a computer program in computer 34 through data cable 40.

One target application of the present invention is the use of identifying thin film semiconductor or optical thin film materials and devices. Due to the nature of these processes, it is desirable for this invention to be mounted to chambers used for creating these materials, so that the measurement could be done in conjunction with normal processing without adding additional process steps just for metrology. It is also a proposed use of this invention to control the material entering or exiting a process tool. The most appropriate place to stop the incorrect insertion of a material into a tool than at the tool itself. It is therefore suggested that the design of the present invention could have the structure shown in FIGS. 3-6 mounted directly onto a load port, orienting chamber, or other location on a process tool that would not interfere with the process and that would detect and identify a material prior to its entering a process to which it is not intended.

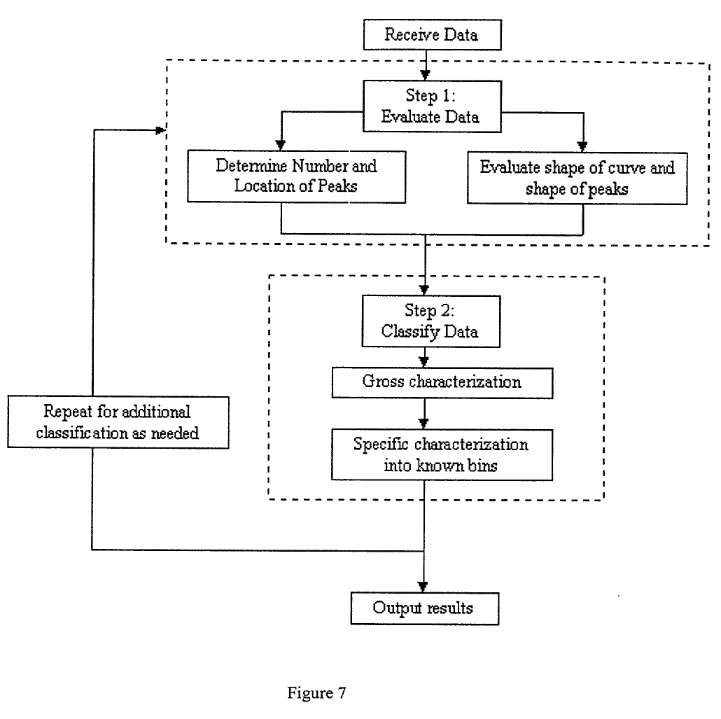

The computer software in computer 34 that receives the intensity signal from the detector 30 and associated electronics will then begin to process the data in order to identify the material. The basic process that this follows is shown in the flowchart of FIG. 7. The first step of this process will be an evaluation of the spectral signal to establish its signature characteristics. The present invention includes a combination of identification of the location and spacing in wavelength and intensity of maxima and minima (collectively referred to as ‘peaks’), the count of the number of peaks in the spectrum, and characteristics of the shape of the spectral curve, including area under the curve. Other peak characterization, in particular determining a wavelength span for broadness of the peak (including but not limited to full width, half maximum characterization) is also a method of identifying the signature of the response in this preferred embodiment.

The next part of the software process for this invention, as shown in FIG. 7, is the means of classification of this signature. This can occur in a number of ways. The present invention uses a combination of gross characterization and specific classification. The gross characterization step is a rough classification that will identify materials from one or more categories and determine whether or not the material currently being measured needs to pass through a more rigorous identification process or not. An example might be looking at samples with more than a single peak versus those with multiple peaks in order to identify a material with a single peak at a given wavelength. This gross characterization step will discard a portion of those samples (those with multiple wavelengths) and then pass into the specific characterization process (determining whether the single peak is at the desired location). The gross characterization step, in this example, would quickly eliminate all samples with multiple peaks, including those that might coincidentally have a peak at the desired wavelength. The gross characterization may also include normalizing or scaling of the data to account for absolute light intensity.

The specific characterization would take the signals passing the gross characterization test and pass it through one or more comparisons to determine exactly in which one of two or more categories the material belongs. The specific characterization may include normalization or scaling of the data to account for changes in light intensity. It may include peak evaluation, such as the example described above to place a peak at a specific wavelength or count the number or spacing of multiple peaks. Or, it may include the comparison with a previously acquired spectral signature from a known sample of a given category, using a least squares fitting or other mathematical approach for comparing the agreement or difference between two signature spectra.

The third step of the software portion of the invention consists of repeating the above two steps as often as necessary to determine the identity of the material. This repetition may use the same criteria as the prior pass, looking for a different member with each pass. Or, as in the present invention database comparison, each pass through the first two steps will completely solve for members of the classes it tests for, and if that pass fails to identify the material the software will change criteria used in steps 1 and 2 to go through a new set of tests to identify the material.

Once the material is classified or identified, the invention will have the ability to send an electrical digital or analog output to signify and sort the category in which the material belongs. This signal output comes from the electronics system 36 that houses the detector and lamp. It is additionally contemplated that the signal can come from a digital or analog board placed in the computer 34.

The invention could also be used in conjunction with a wafer sorting system to remove the unacceptable samples (those classified as being of a type unacceptable to the process tool). The electrical output signal will be used a pass/fail parameter, where the signal is sent if the material belongs to one of a number of classes identified.

Alternate embodiments of the invention that does the specific identification task of determining whether or not semiconductor wafers with metal, wafers with oxide over metal, or wafers with patterned oxide over metal that have metal exposed are present is a preferred application of this invention. Having a similar application and also being able to distinguish whether or not the material has photoresist on it is another application.

Additional modifications and improvements of the present invention may also be apparent to those skilled in the art. Thus, a particular combination of parts described and illustrated herein is intended to represent only certain embodiments of the present invention, and is not intended to serve as limitations of alternative devices within the spirit and scope of the invention.

What is claimed is:

1. A spectral identification system which includes:
a) an broad spectrum light source with wavelengths from ultra-violet to near infra-red;
b) an illumination optical fiber coupled to said light source for transmission light from the light source for illuminating a sample adjustable to a fixed angle of incidence relative to the sample;
c) a detection fiber for receiving reflected light from the surface of a sample or product adjustable to a fixed angle of incidence relative to the sample or product coupled to a light detector;
d) said light detector capable of collecting light across a plurality of optical frequencies of light in the ultra-violet to near infra-red and in communication with electronics for translating the detected light into an electrical signal;
e) a processor for receiving said electrical signals and comparing said signals to a preprogrammed database for identifying the category of the product; and
f) an output circuit to signal the samples category.

2. A system according to claim 1 where said illumination optical fiber and said detection fiber are mounted to a single beam splitter.

3. A system according to claim 1, where the light source is a Tungsten-Halogen or Quartz-Tungsten-Halogen lamp.

4. A system according to claim 1 where the detector is a silicon-based Charge-Coupled Device (CCD) array.

5. A system according to claim 1 where the detector is a photodiode array.

6. A system according to claim 1 where the detector is a scanning monochromator.

7. A system according to claim 1 where the detector is a set of fixed monochromatic detectors.

8. A system according to claim 1 where the method of data processing is detection of the locations of minima and maxima in the optical signal.

9. A system according to claim 8 where the method of comparison includes comparing the peak number and locations with the number and location of peaks expected for each of a number of possible samples.

10. A system according to claim 1 where a method of comparison is through a normalization of intensity followed by a comparison against a set of expected optical signatures.

11. A system according to claim 10 where the comparison against a set of expected signatures is accomplished through a least-squares fitting mathematical calculation.

12. A spectral identification system which includes:
a) a quartz-tungsten-halogen light source;
b) an optical fiber coupling said lamp to a beam splitter with a lens for focusing light to illuminate a sample, and an adjustable mount allowing for a angle of incidence of light at normal incidence relative to the sample or product;
c) a means of mounting the optical fiber and beam splitter on a process tool chamber so that an inline measurement can be performed;
d) a second lens for focusing the light onto a receiving fiber, also attached to the beam splitter;
e) a silicon based ccd-array detector coupled to said receiving fiber;
f) electronics capable of translating a signal from said detector into an electrical signal;
g) a processor for receiving said electrical signal to determine the signature of this multi-wavelength spectral response, and through a comparison with a database of expected product signatures to identify the sample or product as being a member of one of two or more categories of product; and
h) a means of sending an electrical signal output to signify to which category the product belongs.

13. A system according to claim 12 where the method of data processing is detection of the locations of minima and maxima in the optical signal.

14. A system according to claim 13 where the method of comparison includes comparing the peak number and locations with the number and location of peaks expected for each of a number of possible samples.

15. A system according to claim 12 where the method of comparison is through a normalization of intensity followed by a comparison against a set of expected optical signatures.

16. A system according to claim 15 where the comparison against the set of expected signatures is accomplished through a least-squares fitting mathematical calculation;

17. A spectral identification system which includes:
a) a quartz-tungsten-halogen light source;
b) an optical fiber coupled to said light source to a beam splitter with a lens for focusing the light and illuminating a sample, and an adjustable mount allowing for a angle of incidence of light at normal incidence relative to the sample;
c) a means of mounting the optical fiber and beam splitter on a process tool chamber so that an inline measurement can be performed;
d) a second lens for focusing the light onto a receiving fiber, also attached to the beam splitter;
e) a silicon based CCD array detector;
f) electronics for translating the detector signal into an electrical voltage or current.
g) a processor for receiving said signal that signal to determine the signature of this multi-wavelength spectral response and comparison of the signature with a preprogrammed database of expected product signatures to identify the sample or product as being one of the following categories:
1. semiconductor substrate with no intentionally deposited layers;
2. semiconductor wafer with blanket oxide as top layer, with or without metal directly beneath it;
3. semiconductor wafer with metal as top layer
4. semiconductor wafer with patterned oxide as top layer, with metal directly beneath it (and exposed metal corresponding to the pattern in the oxide);
5. semiconductor wafer with photoresist over metal as the top two layers;
6. semiconductor wafer with photoresist as the top layer and a material other than metal as the second layer; and
h) a means of sending an electrical signal output to signify to which category the product belongs.
